(19) United States
(12) Patent Application Publication
(10) Pub. No.: US 2026/0079094 A1
(43) Pub. Date: Mar. 19, 2026

(54) Cascaded Optical Ring Resonator

(71) Applicant: UNIVERSITEIT TWENTE, Enschede (NL)

(72) Inventors: Lantian Chang, Enschede (NL); Zheng Zheng, Enschede (NL); Sonia Maria Garcia Blanco, Enschede (NL); Ward Arnoldus Petrus Marinus Hendriks, Enschede (NL); Ying Wang, Enschede (NL)

(21) Appl. No.: 19/108,071

(22) PCT Filed: Aug. 17, 2023
(86) PCT No.: PCT/NL2023/050428

§ 371 Date: Feb. 28, 2025

(30) Foreign Application Priority Data
Aug. 28, 2022 (NL) 2032867

(51) Int. Cl. G01N 15/075

(52) U.S. Cl. CPC G01N 15/075

(57) ABSTRACT

The present invention relates to an optical detector and to an optical detection method. The present invention further relates to an optical sensor and to a method for detecting the quantity and/or presence of a specific molecules in a fluid.

The optical detector of the present invention comprises a cascaded optical ring resonator and is characterized in that the processing unit used for processing the detector signal is configured to obtain Transform, T, data by performing a first transform on the detector signal, to select respective T data for each of the closed-loop optical waveguides among the T data, and to perform a second transform being an inverse of the first transform on the selected respective T data for each of the closed-loop optical waveguides, wherein the first transform is configured for transforming data in the time domain to data in the frequency domain.

The present invention relates to an optical detector and to an optical detection method. The present invention further relates to an optical sensor and to a method for detecting the quantity and/or presence of specific molecules in a fluid.

In recent optical sensing technology, enhancing the measurement efficiency is one of the most important objectives. Optical ring resonator sensing increasingly attracts attention, as optical ring resonator-based sensors display high sensitivities, because of their narrow resonance peaks and high-quality factors. These sensors provide a platform for biological sensing and chemical analysis. Optical ring resonators comprise closed-loop waveguide structures coupled to one or more linear or curved waveguides.

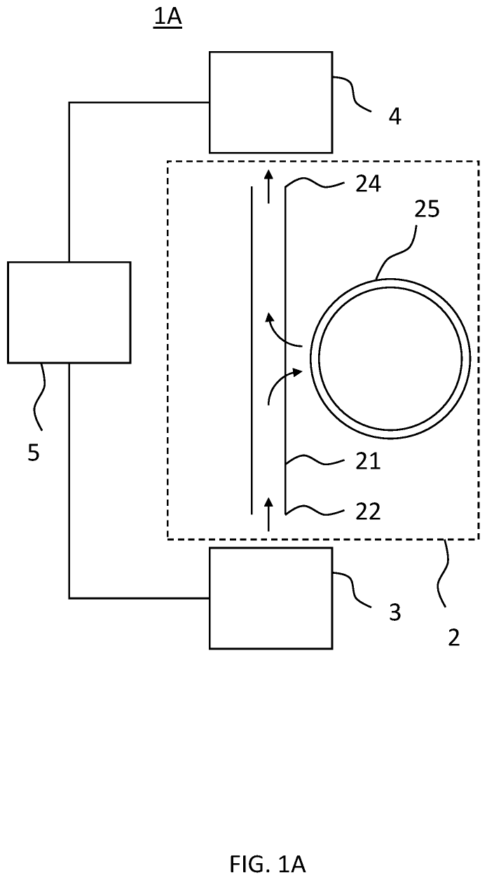

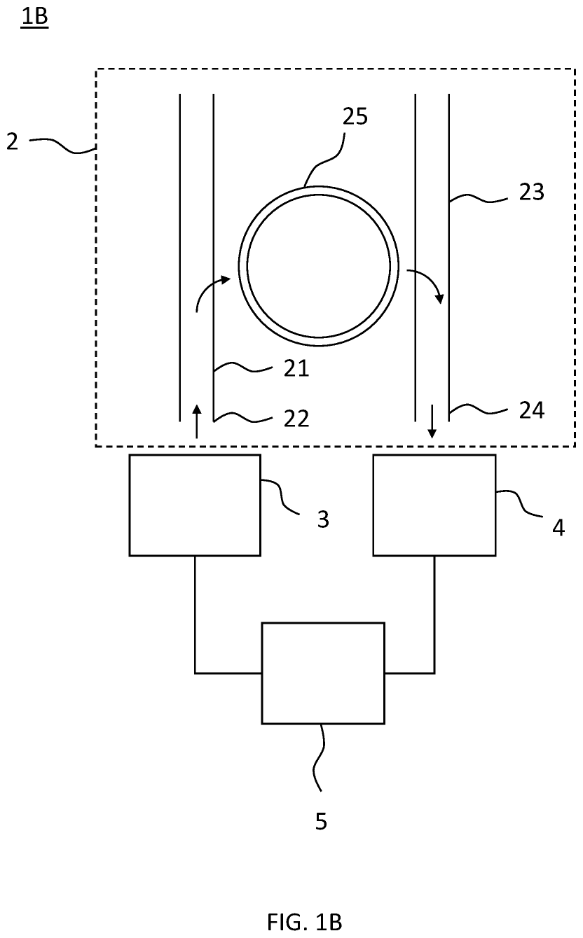

FIGS. 1A and 1B illustrate two examples of a known optical detector 1A, 1B. Both detectors 1A, 1B comprises an optical ring resonator 2 comprising an input optical waveguide 21 having an input end 22 and an output optical waveguide having an output end 24, and a closed-loop optical waveguide 25 that is optically coupled to input optical waveguide 21 for allowing light to couple from input optical waveguide 21 into closed-loop optical waveguide 25. In FIG. 1A, input optical waveguide 21 is also used as output optical waveguide, whereas in FIG. 1B, a separate output optical waveguide 23 is used. In both cases, closed-loop optical waveguide 25 is optically coupled to output optical waveguide 21, 23 for allowing light to couple from closed-loop optical waveguide 25 into output optical waveguide 21, 23.

Detectors 1A, 1B further comprise a tunable monochromatic light source 3, such as a laser, configured to couple light into input end 22 of input optical waveguide 21, wherein light source 3 is configured to vary a frequency of the light coupled into input end 22 of input optical waveguide 21 within a scanning range.

Detectors 1A, 1B also comprise a detecting unit 4 optically coupled to output end 24 of output optical waveguide 21, 23 and configured to output a detector signal. A processing unit 5 is provided for processing the detector signal. Processing unit 5 may control light source 3 to perform a scanning operation and/or may receive information about the frequency or frequency range of the light coupled into input optical waveguide 21. This information may also be manually entered or provided to processing unit 5 in other ways.

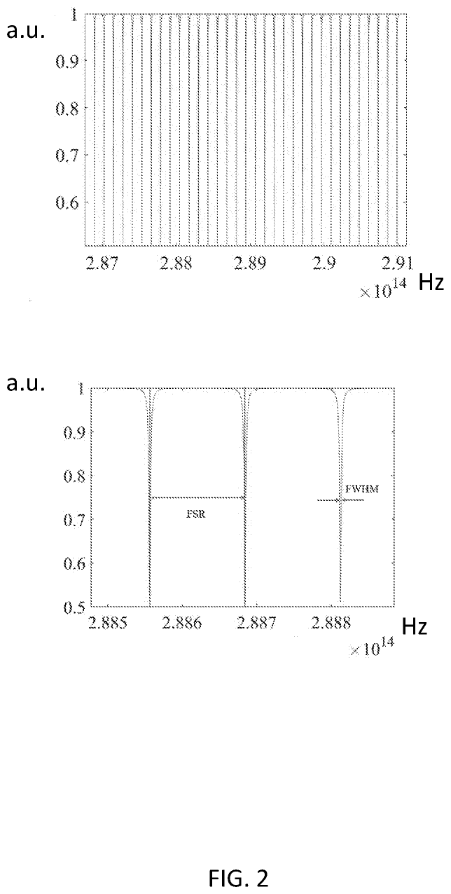

The periodic transmission function of single optical ring resonator 2 of detector 1A as measured by detecting unit 4 is shown in FIG. 2. As shown, the transmission function as function of frequency displays valleys. The frequency at which these valleys occur corresponds to the condition in which the optical path length inside closed-loop optical waveguide 25 matches a multiple of the wavelength of the light inside closed-loop optical waveguide 25. At such frequencies, light energy accumulates inside closed-loop optical waveguide 25. Furthermore, the light inside closed-loop optical waveguide 25 couples to output optical waveguide 23 albeit with a 180 degrees phase shift compared to the light that is coupled from input optical waveguide 21. Accordingly, due to destructive interference, a drop in transmission can be observed.

The periodic transmission function of single optical ring resonator 2 of detector 1B as measured by detecting unit 4 displays peaks instead of valleys as at the resonance frequencies, light that has accumulated in closed-loop optical waveguide 25, is coupled to output optical waveguide 23.

As the wavelength of the light is very small compared to the radius of closed-loop optical waveguide 25, many resonances occur in a relatively narrow frequency range. Moreover, the effective refractive index of closed-loop waveguide 25, defined as the ratio between the free-space velocity and the waveguide phase velocity, depends on the refractive indexes of both the cladding layer and core layer of this waveguide and is generally frequency dependent. By making the refractive index of the cladding layer dependent on the presence of specific molecules, it becomes possible to use optical ring resonator 2 as a sensor. For example, by monitoring the behavior of one or more resonance peaks, a qualitative and/or quantitative measure can be provided regarding the presence of specific molecules in a fluid that passes over the waveguide.

FIG. 2 further illustrates two figures of merit. Firstly, the free spectral range, FSR, indicates the difference in frequency between adjacent resonance peaks. Within a limited frequency range, in which the group refractive index is constant, FSR is constant as well. The full width half maximum, FWHM, indicates the width of the resonance peak.

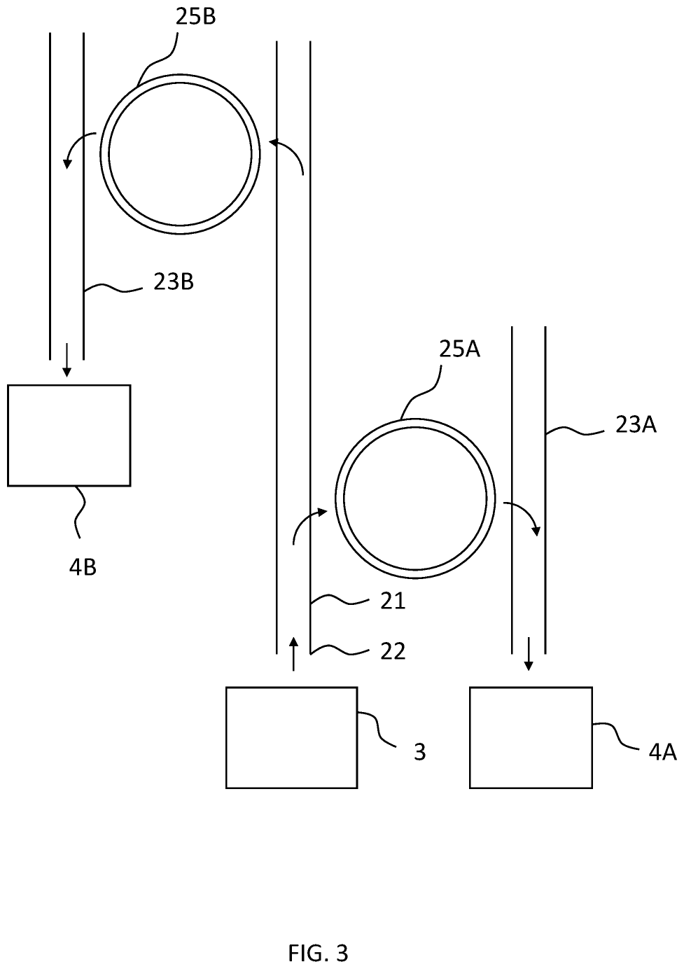

Resonators 1A, 1B can be extended by including multiple closed-loop optical waveguides or rings. An example of an extension of resonator 1B is shown in FIG. 3, wherein processing unit 5 has been omitted. As shown, two detectors 4A, 4B are used for detecting light in output optical waveguides 23A, 23B that has been coupled from rings 25A, 25B.

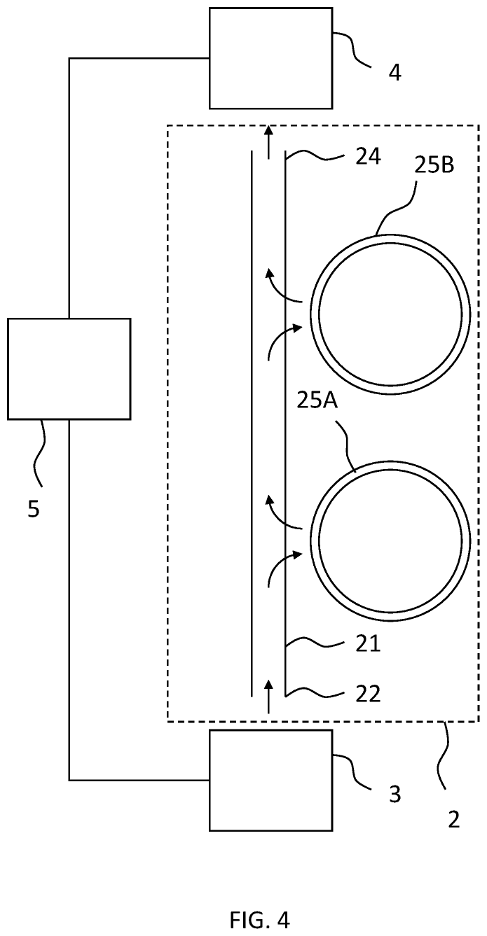

To reduce the number of detectors, it is possible to combine the light from the rings in a single output optical waveguide. For the detector shown in FIG. 3 this would mean that ring 25B would also couple to output optical waveguide 23A. A similar detector, albeit based on detector 1A, is shown in FIG. 4. In both cases, a problem exists in that detecting unit 4 receives light that has originated from rings 25A, 25B. The resonance peaks for rings 25A, 25B may furthermore overlap making it difficult to distinguish which peaks belong to which rings 25A, 25B. In addition, in the original detector data, peaks cannot be identified automatically due to fabrication tolerances that are at least comparable to the optical wavelength. Under these circumstances, it is not clear to which ring 25A, 25B the peaks belong.

The paper “Multiplexed detection of lectins using integrated glycan-coated microring resonators”, by Ghasemi Farshid et al, Biosensors and Bioelectronics, vol. 80, 27-01-2016, pp. 682-690, discloses a sensor array consisting of five SiN microring resonators coupled to a common bus waveguide.

The paper “Multiplexed Sensing Systems Utilising All Fibre Ring Resonators”, by F. Farahi et al, SPIE Smart Structures And Materials+Nondestructive evaluation and health monitoring, 2005, San Diego, California, United States, part 1011, 19-09-1988, pp. 18-25, discloses a system that is illuminated by a relatively short coherence length source such that no interference occurs at each individual ring interferometer but the interference can be observed when the interferometer's path imbalances are matched within the coherence length of the source. It further discloses an arrangement for frequency division multiplexing, which has a series topology and comprises rings of limitingly flow finesse, such that each one may be assumed to behave as a two-beam interferometer.

The paper “Real-time sensing with multiplexed optomechanical resonators”, by F. R. Lamberti et al, ARXIV.ORG, Cornell University Library, 201 OLIN Library Cornell University Ithaca, NY 14853, 9 Jul. 2021, discloses simultaneous frequency measurement of three silicon microdisk resonators fabricated through a VLSI process.

According to its abstract, WO 2016/120661A1 discloses an optical wavelet transform or inverse wavelet transform medium for implementing optical multiwavelet orthogonal Frequency Division Multiplexing or optical demultiplexing.

It is an object of the present invention to provide an optical detector in which the abovementioned problem is at least partially solved.

To this end, the present invention provides an optical detector that is characterized in that the processing unit is configured to obtain Transform, T, data by performing a first transform on the detector signal, to select respective T data for each of the closed-loop optical waveguides among the T data, and to perform a second transform being an inverse of the first transform on the selected respective T data for each of the closed-loop optical waveguides. Here, the first transform is configured for transforming data in the time domain to data in the frequency domain.

The Applicant has found that identification of peaks in the original data, meaning localizing peaks in the original data and attributing these localized peaks to the correct closed-loop optical waveguide, is cumbersome at best when multiple closed-loop optical waveguides are used. This is due to the fact that peaks will sometimes overlap thereby producing a complex picture.

The Applicant has further found that by using a first transform that is configured for transforming data in the time domain to data in the frequency domain, peaks can more easily be identified. More in particular, the peaks are selected in the transformed data and because they can be associated with a particular closed-loop optical waveguide, it becomes possible to collect data for each closed-loop optical waveguide separately and to, by performing the corresponding inverse transform, transform the transformed data to the original domain. These latter inverted data are more susceptible to perform analysis on. For example, all the peaks in a single set of inverted data correspond to one particular closed-loop optical waveguide.

The first transform can be a transform among a short-time Fourier transform, a wavelet transform, a Hilbert-Huang transform, an empirical mode decomposition, local mean decomposition, Wigner-Ville distribution, spectral kurtosis, Cohen's class, a Discrete Fourier Transform, DFT, and a Stockwell transform. The first transform is preferably a DFT and the second transform an Inverse Discrete Fourier Transform, IDFT, wherein the processing unit is preferably configured to perform the DFT based on a Fast Fourier Transform, and to perform the IDFT based on an Inverse Fast Fourier Transform.

The closed-loop optical waveguides can be configured to support higher-order transverse modes, and the light that travels inside the closed-loop optical waveguide may comprise a higher order transverse mode. Typically, higher order transverse modes are more susceptible to changes in the refractive index of the cladding layer of the closed-loop optical waveguides. In combination with the fundamental mode inside the closed-loop optical waveguides a higher dynamic range can be achieved.

Hereinafter, a DFT will be used as an example of the first transform. However, the present invention is not limited to such transform.

In general, the DFT transform X(k) of a series of data points xₙ can be found using:

$$X ( k ) = {\sum }_{n = 0}^{N - 1} {x}_{n} {e}^{- jnk 2 π / N}$$

wherein N equals the total amount of data points, n and k are integers, and wherein 0≤k≤N−1.

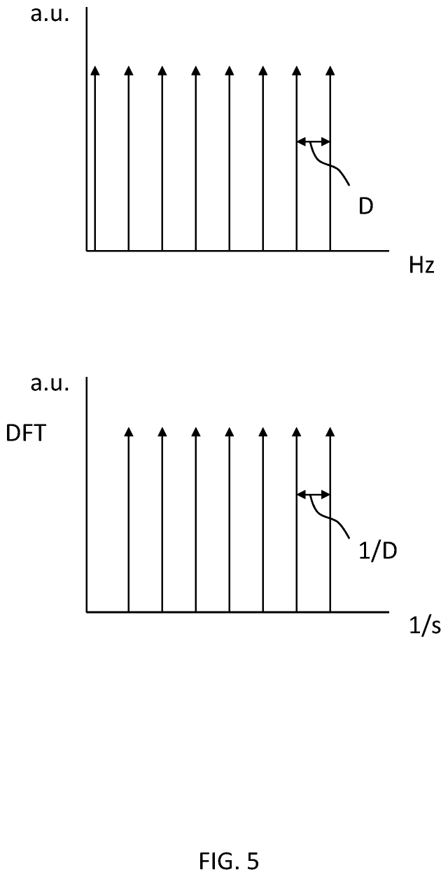

By performing a DFT on detector signal data, which comprises a series of numbers and of which an ideal example for a single ring resonator is shown in FIG. 5 (top), periodic DFT data can be achieved as shown in FIG. 5 (bottom). The free spectral range D is translated into a spacing between peaks in the DFT data equaling 1/D. Here, it is noted that the scale of the x-axis of the top figure is obtained by associating the index numbers of the data points, e.g. 0, 1, 2, etc., with the corresponding frequency. Similar considerations hold for the bottom figure.

An advantage of using the transformed data is that the peaks are regularly spaced relative to the first data point for which k=0. The position of peaks in the transformed data therefore corresponds to

$$k = \frac{O r d}{D} ,$$

wherein Ord is an integer larger than zero that represents the order of the peak in the transformed data.

The input optical waveguide can be formed by a first part of a main optical waveguide and the output optical waveguide can be formed by a second part of the main optical waveguide. Furthermore, the main optical waveguide is preferably a straight optical waveguide of which one end forms the input end and an opposing end forms the output end, however the present application does not exclude curved optical waveguides. This configuration corresponds to the detector shown in FIG. 4. However, the present invention is not limited to this configuration and equally applies to other configurations.

The processing unit can be configured to select respective T data for a given closed-loop optical waveguide based on a position of a selected peak in the T data that corresponds to resonance in said given closed-loop optical waveguide and an order of that peak in the T data. The detector signal outputted by the detecting unit typically comprises a series of numbers. Moreover, the detector typically only measures the intensity of the incoming light in a non-frequency specific manner. The position of the peak may correspond to the position of the data point of that peak or valley in the series of numbers.

When the light source performs a scanning operation in which light with a varying wavelength or frequency is inputted into the input optical waveguide, a plurality of peaks and valleys will be detected by the detecting unit. The order of a peak in the T data indicates whether it concerns the first, second, third, etc. peak in the pattern of peaks.

The wavelength of the light that is inputted into the input optical waveguide at a given moment in time is typically determined indirectly. For example, the frequency scanning range used by the light source is known. Assuming that this range is divided into equal steps, each data point can be attributed to a particular frequency. The present invention does not exclude embodiments in which the frequency of the light is measured. Regardless, for applying the method of using a first and second transform to determine the data for a given closed-loop optical waveguide, it is not required in all cases to know the correlation between the position of the data points and the frequency of the corresponding light.

The processing unit can further be configured to select respective T data for a given closed-loop optical waveguide by determining other peaks in the T data that correspond to resonance in said given closed-loop optical waveguide, said other peaks having a different order than the order of the selected peak. For example, if a peak is selected of which the order is 3, meaning that it is the third peak of the given closed-loop optical waveguide occurring in the T data, it is possible to determine the other peaks. When using DFT for example, the first peak can be found using the position of the selected peak divided by 3, the second peak using the position of the selected peak divided by 3 and multiplied by 2. In general, as discussed above, the position k of any peak of order Ord can be found using

$$k = \frac{O r d}{D} .$$

The processing unit can be configured to select the respective T data for a given closed-loop optical waveguide by selecting a predefined number of data points in the T data that includes and surrounds the determined other peaks and that includes and surrounds the selected peak. For example, if the data points having a position of 100, 200, 300, 400, 500 in the T correspond to peaks, data points having a position in the ranges 96-104, 196-204, 296-304, 396-404, 496-504 can be selected.

The processing unit can be configured to use default values as data points of the selected respective T data for each given closed-loop optical waveguide to complement the selected respective T data for that closed-loop optical waveguide to obtain a number of data points of the selected respective T data that is equal to the number of data points of the T data. For example, if the original data comprises 1000 data points, and 40 points with a given position are selected in the T data for a given closed-loop optical waveguide, values for the other positions in the data can be set to a default value. Here, the default value should be such that the resulting IT data does not significantly depend on the default value. For example, the default value could be zero.

The processing unit can be configured to receive a user selection for each of the closed-loop optical waveguides of a data point corresponding to peak in the respective T data and to receive an indication of the order of that peak. For example, a user may be presented with the T data on a computer screen, and may, using a user interface, select a particular peak for a given closed-loop optical waveguide. Alternatively, the abovementioned selection can be performed automatically. For example, by having knowledge about the number and sizes of the closed-loop optical waveguides, and the group refractive index, an appropriate search window can be defined. Here, both the size and position of the search window can be defined. Using the search window, a group of adjacent data points can be searched for in the T data that comprises a number of peaks that can be expected given the number of closed-loop optical waveguides and optional higher-order transverse modes. Separate search windows can be defined for different orders of the peaks that are to be sought.

For example, again assuming a DFT for illustrative purposes and assuming an effective refractive index n_{eff}(f) of which a change during the scanning is very small compared to n_{eff}(f) itself, resonance inside the closed-loop optical waveguide will occur when:

$$L = m λ = m \frac{c}{{n}_{eff} ( f ) \cdot f}$$

wherein L is the perimeter of a closed-loop optical waveguide, m a non-zero integer, A the wavelength, and f the frequency. In case of a simple ring with radius of R, L=2πR. FSR, the distance in frequency between a peak for m and m+1 can be found using:

$$D = F S R = \frac{c}{{n}_{g} ( f ) \cdot L}$$

where n_{g} is the group refractive index. The position k of any peak of order Ord in the T data can be found using

$$k = \frac{O r d}{D} = \frac{O r d * {n}_{g} * L}{c} .$$

Accordingly, larger closed-loop waveguides will result in peaks that occur at higher frequencies and that are spaced further apart than smaller closed-loop waveguides.

During a typical sensing or detecting process, n_{eff}(f) and thus n_{g}(f) will change depending on the applied stimulus. However, similar to the effective group refractive index, the changes in n_{g}(f) are so small compared with n_{g}(f) itself, that these changes have no significant influence on the process of selecting the peak positions. The information on the amount of shift in the resonance peaks is contained in the phase information of the selected T peaks.

The processing unit can be configured to obtain for each closed-loop optical waveguide Inverse Transform, IT, data by performing the second transform on the selected respective T data for that closed-loop optical waveguide. For example, if five closed-loop optical waveguides are used, five sets of IT data will be obtained. Furthermore, the processing unit can be configured to determine or calculate at least one resonance frequency at which resonance occurs for each closed-loop optical waveguide based on the IT data for that closed-loop optical waveguide. In some embodiment, all the peaks in the IT data for a given closed-loop optical waveguide are determined or calculated. For example, the processing unit can be configured to determine or calculate said at least one resonance frequency for each closed-loop optical waveguide by determining the position of at least one peak or valley in the IT data for that closed-loop optical waveguide.

As stated before, the original data and the IT data comprise a series of numbers of which the correlation with the frequency or wavelength of the light is known or can be determined. For example, the processing unit may control the scanning range of the light that is coupled by the tunable monochromatic light source into the input end of the input optical waveguide. Dividing the scanning range, expressed in Hz, into equal steps provides information about which frequency corresponds to which data point.

Additionally or alternatively, the processing unit can be configured to receive information about the scanning range, and the processing unit can be configured to determine or calculate the at least one resonance frequency based on the position of the at least one peak or valley in the IT data for that closed-loop optical waveguide and the received information.

The tunable monochromatic light source can be configured to repeatedly vary the wavelength of the light coupled into the input end of the input optical waveguide within the same scanning range during a plurality of scans, and wherein the processing unit is configured to determine said at least one resonance frequency for each closed-loop optical waveguide for each scan. In this manner, it becomes possible to monitor the position of the at least one resonance frequency over time.

The processing unit can be configured to output the determined at least one resonance frequency for each closed-loop optical waveguide.

Each of the input optical waveguide, output optical waveguide, and closed-loop optical waveguides can be a buried channel waveguide, a ridge channel waveguide, or a strip-loaded channel waveguide, of which a waveguide core can be made of Si, SiN, SiON, Al₂O₃, TiO, AlN, and InP of which a waveguide cladding can be made of SiO₂, PDMS, PMMA. In some cases, the cladding on one side of the waveguide will be formed by the surrounding gas or liquid.

The processing unit can be configured to determine an effective refractive index of the closed-loop optical waveguide and/or an optical wavelength inside the closed-loop optical waveguide for each closed-loop optical waveguide based on the determined at least one resonance frequency for that closed-loop optical waveguide. Both quantities depend on the refractive index of the cladding layer. In some applications, the cladding layer is designed to change its refractive index as a function of a particular stimulus. Such stimulus can be a change in temperature, pressure, or the presence of specific molecules.

According to a further aspect, the present invention provides an optical sensor that comprises the optical detector as described above and a sensor processing unit configured to output a sensor signal based on a comparison between at least part of the IT data for each closed-loop optical waveguide and reference data or, when applicable, based on a comparison of at least part of the IT data for each closed-loop optical waveguide for different scans. The at least part of the IT data may comprise at least one resonance frequency at which resonance occurs for each closed-loop optical waveguide based on the IT data for that closed-loop optical waveguide. Here, it is noted that the abovementioned reference data may also comprise IT data for another closed-loop optical waveguide.

The cladding layer of at least one closed-loop optical waveguide can be connected to or is at least partially formed by a sensing layer that is configured to couple to specific molecules, wherein as a result of said coupling, the refractive index of the cladding layer changes. For example, the sensing layer may comprise a gas absorbing or gas reacting layer, an antibody or an antigen.

According to a further aspect, the present invention provides a method for detecting the quantity and/or presence of a specific molecules in a fluid. This method comprises providing the optical sensor as defined above and allowing the fluid to flow over the waveguide that is connected to or at least partially formed by said sensing layer of at least one closed-loop optical waveguide of the optical sensor. The method further comprises detecting the quantity and/or presence of the specific molecules in dependence of the sensor signal.

According to a further aspect, the present invention provides an optical detection method that comprises providing a cascaded optical ring resonator comprising an input optical waveguide having an input end and an output optical waveguide having an output end, and a plurality of closed-loop optical waveguides that are each optically coupled to the input optical waveguide for allowing light to couple from the input optical waveguide into the closed-loop waveguide, and that are each optically coupled to the output optical waveguide for allowing light to couple from the closed-loop waveguide into the output optical waveguide. The method further comprises coupling light into the input end of the input optical waveguide of which a frequency of the light is varied within a scanning range, detecting light at the output end of the output optical waveguide and outputting a detector signal, and processing the detector signal.

According to the present invention, the method is characterized in that said processing the detector signal comprises obtaining Transform, T, data by performing a first transform on the detector signal, selecting respective T data for each of the closed-loop optical waveguides among the T data, and performing a second transform being an inverse of the first transform on the selected respective T data for each of the closed-loop optical waveguides, wherein the first transform is configured for transforming data in the time domain to data in the frequency domain.

Next, the present invention is explained in more detail by referring to the appended figures, wherein similar or identical components are referred to using the same reference signs, and wherein:

FIGS. 1A and 1B illustrated two known optical detectors comprising a single ring optical resonator;

FIG. 2 illustrates the transmission function of an optical detector comprising a single ring optical resonator;

FIGS. 3 and 4 illustrate extensions of the known optical detectors to include more rings;

FIG. 5 illustrates an example of a DFT on a series of numbers that shows periodicity;

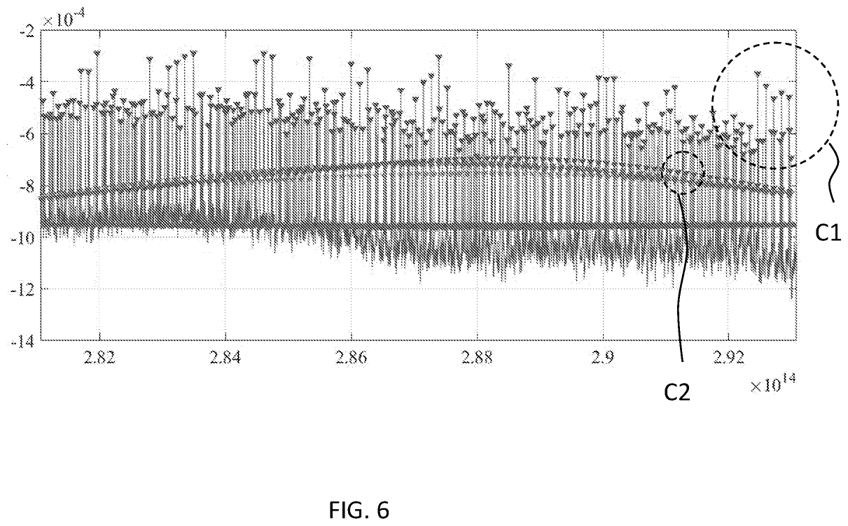

FIG. 6 provides a comparison between the original data and a superposition of IDFT data for an optical detector having four closed-loop optical waveguides;

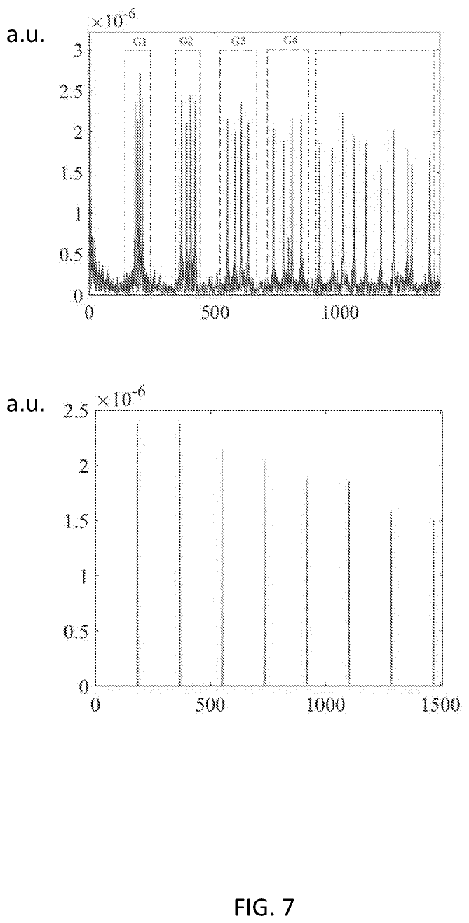

FIG. 7 illustrates peak selection and selection of DFT data for the data shown in FIG. 6; and

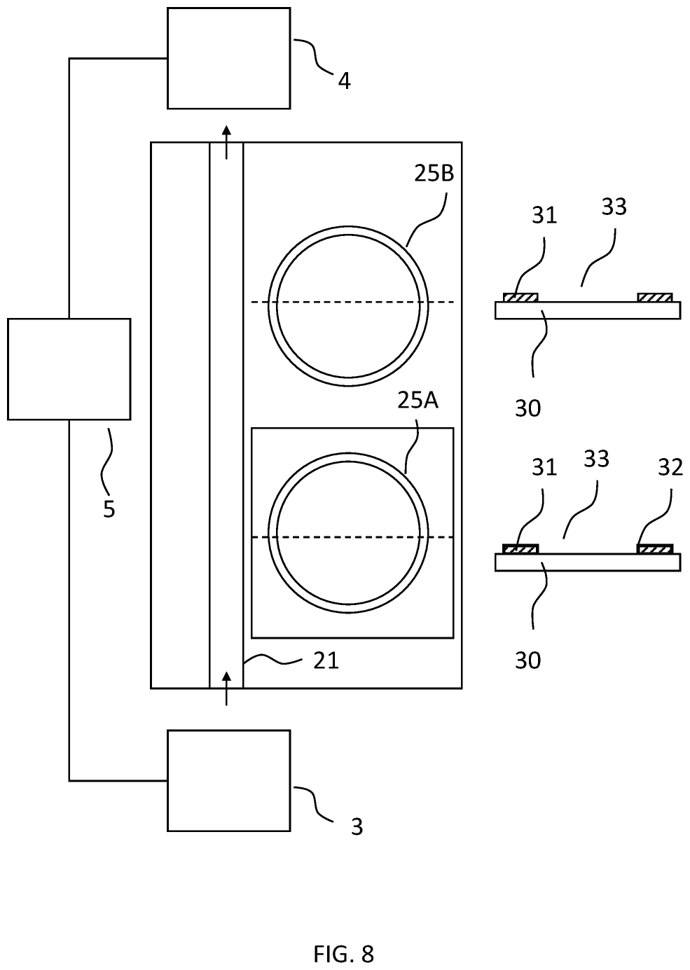

FIG. 8 illustrates an example of an optical sensor in accordance with the present invention.

In the following description of the invention, DFT and IDFT are used as examples of the first and second transform, respectively. However, the present invention is not limited to these transforms.

A comparison between original data and a superposition of IDFT data for an optical detector having four closed-loop optical waveguides is shown in FIG. 6. In this case, the detector signal, which comprises a series of numbers and hereinafter referred to as the original data, shows a somewhat irregular distribution of peaks. In FIG. 6, some of these peaks are encircled by circle C1. Furthermore, it is noted that for the optical detector of which the response is shown in FIG. 6, the detecting unit is configured to output a maximum output signal when no light is detected corresponding to resonance inside a closed-loop optical waveguide.

FIG. 7, top, illustrates the result after applying a DFT, more in particular a Fast Fourier Transform, FFT, to the original data. As shown, for the first data points, i.e. the points close to the Y-axis, the peaks can be divided into groups G1-G4 of peaks that are closely spaced. Beyond G4 such classification is no longer possible or easy to perform automatically due to peak mixing from different groups. This is shown in the last dashed rectangle in the figure.

It is advantageous to select peaks in the highest group when possible. This is due to the fact that the position of peaks in the DFT data corresponds to

$$k = \frac{O r d}{D} ,$$

wherein Ord is an integer larger than zero that represents the order of the peak in the DFT data, and D the FSR. To determine the peaks, a value of k has to be selected and a D value has to be attributed to that value. The value of k may have a small error in the sense that the true value is somewhat higher or lower. This error is not proportional to the value of k. Assuming this error Ek to be constant, one finds for the error ED:

$${D}^{*} + E D = \frac{Ord}{{k}^{*} + E k}$$

wherein D* is true FSR. Accordingly, using peaks with a high value of k offers the advantage that the effect of the error in this value has a smaller impact on the error in the FSR.

In FIG. 7, top, group G4 was selected. For each peak in the group, for which the order is a 4, the other peaks corresponding to the same closed-loop optical waveguides were found. For example, the FSR can be determined that allows a prediction of the other order peaks. A peak find function can be used to automatically find the other peaks. It should be noted that such function can also be used to determine the abovementioned group G4. Based on knowledge about the number and sizes of the closed-loop optical waveguides, and the group refractive index, a search window can be defined in which the peaks in the IT data of a certain order should be located in. By checking that the number of peaks does correspond to the number that is to be expected based on the number of closed-loop optical waveguides, a group can be selected that has a relatively high order. It is further noted that if the light in the closed-loop optical waveguides comprises higher-order transverse modes, those peaks can be dealt with in a manner similar to that of the regular peaks. These presence of higher-order transverse modes only changes the number of peaks to be present in the search window.

In addition to the peaks themselves, additional data to the left and right of the peaks was selected. This process is performed for all closed-loop optical waveguides. After this process, four sets of DFT data are obtained, one for each closed-loop optical waveguide. An example of the resulting data after selecting is shown in FIG. 7, bottom, for one closed-loop optical waveguide. It should be noted that when selecting data from the original DFT data as data for a particular closed-loop optical waveguide, the position of that data is maintained. Put differently, when selecting a 67^{th} data point in the original DFT data as DFT data belonging to the second closed-loop optical waveguide, this data point assumes the 67^{th} position in the data set for that waveguide. However, not all of the positions in this latter data set are assigned to a value. To address this problem, default values are used at those positions. In the example of FIG. 7, bottom, a default value of 0 was used.

After filling the DFT data sets of each closed-loop optical waveguide, an IDFT is applied to each DFT data set individually. This produces four IDFT data sets, which are shown together in FIG. 6 and of which a small part is encircled by circle C2. As can be seen, the distribution of the peaks is less irregular than the original data.

For each closed-loop optical waveguide, the corresponding IDFT data is used for determining at least one resonance frequency. For example, a peak may be found at the 100^{th} position of a 1000 points data set. The frequency corresponding to this point, fres, can be found using fres=fstart+position of data point (=100)×(fend−fstart)/number of data points (=1000), wherein fstart and fend are the frequency of the light corresponding to the first and last data point, respectively. Here, fend−fstart corresponds to the scanning range.

Allowing at least one resonance peak to be determined enables the detector to be used in a sensor as will be explained referring to FIG. 8.

FIG. 8 illustrates an example of an optical sensor in accordance with the present invention. It comprises the abovementioned optical detector and a sensor processing unit, which in FIG. 8, is incorporated in processing unit 5. It should be noted that processing unit 5 may be embodied using any computing device such as a desktop computer.

In addition, main optical waveguide 21 and closed-loop optical waveguides 25A, 25B can be embodied on a single photonics chip, although the present invention is not limited thereto. Light can be coupled into and out of main optical waveguide 21 using conventional means. This coupling may require optical fibers arranged in between light source 3 and the photonics chip and between the photonics chip and detecting unit 4.

FIG. 8 illustrates two cross-sections corresponding to the hashed lines indicated to the immediate left of these cross-sections. Here, each closed-loop optical waveguide 25A, 25B comprises a bottom cladding layer 30, such as SiO₂, a Al₂O₃ core layer 31, and a coating 32 that is formed of a layer of receptor molecules that are configured to attach to specific biological material or molecules, such as antibodies or antigens, that closed-loop optical waveguides 25A, 25B comes into contact with. Typically, the thickness of this layer is in the order of a monolayer. The liquid stimulate, 33, which is of relatively low refractive material, also forms the cladding layer for closed-loop optical waveguides 25A, 25B. Typically, the thickness of this layer is in the order of a few tens of micrometers.

As a result of the coupling between receptor molecules and the biological material, the effective refractive index of closed-loop optical waveguide 25A will change, thereby causing a change in the resonance frequency. Closed-loop optical waveguide 25B does not comprise such layer and the effective refractive index will therefore not change when it comes into contact with these molecules.

By bringing at least closed-loop optical waveguide 25A into contact with the fluid, and by monitoring the resonance peaks of closed-loop optical waveguide 25A over time, by repeatedly performing a scanning operation, changes in the at least one resonance frequencies can determined. These changes allow a quantitative and/or qualitative assessment on the presence of the specific molecules in the fluid. By comparing the at least one resonance frequencies to those of closed-loop optical waveguide 25B, a further refinement can be obtained. For example, due to temperature changes, the resonance frequencies may shift even in the absence of the specific molecules. By comparing the peaks between closed-loop optical waveguides 25A, 25B such change can be corrected for. For example, the change in effective refractive index can be split into a part associated with a change in temperature and a change associated with the attachment of the specific molecules.

The abovementioned approach can be used for other applications as well provided that the effective refractive index changes as a result of the stimulus that needs to be assessed.

In the above, the present invention has been explained using detailed embodiments thereof. However, the present invention is not limited to these embodiments and other embodiments are possible without deviating from the scope of the present invention, which is defined by the appended claims and their equivalents.

1. An optical detector, comprising:
a cascaded optical ring resonator comprising an input optical waveguide having an input end and an output optical waveguide having an output end, and a plurality of closed-loop optical waveguides that are each optically coupled to the input optical waveguide for allowing light to couple from the input optical waveguide into the closed-loop waveguide, and that are each optically coupled to the output optical waveguide for allowing light to couple from the closed-loop waveguide into the output optical waveguide;
a tunable monochromatic light source configured to couple light into the input end of the input optical waveguide, wherein the light source is configured to vary a frequency of the light coupled into the input end of the input optical waveguide within a scanning range;
a detecting unit optically coupled to the output end of the output optical waveguide and configured to output a detector signal; and
a processing unit for processing the detector signal;
wherein the processing unit is configured to obtain transform, T, data by performing a first transform on the detector signal, to select respective T data for each of the closed-loop optical waveguides among the T data, and to perform a second transform being an inverse of the first transform on the selected respective T data for each of the closed-loop optical waveguides;
wherein the first transform is configured for transforming data in the time domain to data in the frequency domain.

2. The optical detector according to claim 1, wherein the first transform is a transform among a short-time Fourier transform, a wavelet transform, a Hilbert-Huang transform, an empirical mode decomposition, local mean decomposition, Wigner-Ville distribution, spectral kurtosis, Cohen's class, a Discrete Fourier Transform, DFT, and a Stockwell transform.

3. The optical detector according to claim 2, wherein the first transform is a DFT and the second transform an Inverse Discrete Fourier Transform, IDFT, wherein the processing unit is configured to perform the DFT based on a Fast Fourier Transform, and to perform the IDFT based on an Inverse Fast Fourier Transform.

4. The optical detector according to claim 1, wherein the closed-loop optical waveguides are configured to support higher-order transverse modes, and wherein the light that travels inside the closed-loop optical waveguide comprises higher order transverse modes.

5. The detector according to claim 1, wherein the input optical waveguide is formed by a first part of a main optical waveguide and wherein the output optical waveguide is formed by a second part of the main optical waveguide,
wherein the main optical waveguide is a straight optical waveguide of which one end forms the input end and an opposing end forms the output end.

6. (canceled)

7. The detector according to claim 1, wherein the processing unit is configured to select respective T data for a given closed-loop optical waveguide based on a position of a selected peak in the T data that corresponds to resonance in said given closed-loop optical waveguide and an order of that peak in the T data,
wherein the processing unit is configured to select respective T data for a given closed-loop optical waveguide by determining other peaks in the T data that correspond to resonance in said given closed-loop optical waveguide, said other peaks having a different order than the order of the selected peak,
wherein the processing unit is configured to select the respective T data for a given closed-loop optical waveguide by selecting a predefined number of data points in the T data that includes and surrounds the determined other peaks and that includes and surrounds the selected peak.

8. (canceled)

9. (canceled)

10. The detector according to claim 7, wherein the processing unit is configured to use default values as data points of the selected respective T data for each given closed-loop optical waveguide to complement the selected respective T data for that closed-loop optical waveguide to obtain a number of data points of the selected respective T data that is equal to the number of data points of the T data, said default values to be used for the selected respective T data for a given closed-loop optical value corresponding to values the T data would have if no light had been coupled from the input waveguide into that closed-loop optical waveguide.

11. (canceled)

12. The detector according to claim 7, wherein the processing unit is configured to receive a user selection for each of the closed-loop optical waveguides of a data point corresponding to peak in the respective T data and to receive an indication of the order of that peak.

13. The detector according to claim 1, wherein the processing unit is configured to obtain for each closed-loop optical waveguide Inverse Transform, IT, data by performing the second transform on the selected respective T data for that closed-loop optical waveguide.

14. The detector according to claim 13, wherein the processing unit is configured to determine or calculate at least one resonance frequency at which resonance occurs for each closed-loop optical waveguide based on the IT data for that closed-loop optical waveguide, wherein the processing unit is configured to determine or calculate said at least one resonance frequency for each closed-loop optical waveguide by determining the position of at least one peak or valley in the IT data for that closed-loop optical waveguide.

15. (canceled)

16. The detector according to claim 14, wherein the processing unit controls the scanning range of the light that is coupled by the tunable monochromatic light source into the input end of the input optical waveguide and/or wherein the processing unit is configured to receive information about the scanning range, and wherein the processing unit is configured to determine or calculate the at least one resonance frequency based on the position and order of the at least one peak or valley in the IT data for that closed-loop optical waveguide and the received information.

17. The detector according to claim 14, wherein the tunable monochromatic light source is configured to repeatedly vary the wavelength of the light coupled into the input end of the input optical waveguide within the same scanning range during a plurality of scans, and wherein the processing unit is configured to determine said at least one resonance frequency for each closed-loop optical waveguide for each scan.

18. The detector according to claim 14, wherein the processing unit is configured to output the determined at least one resonance frequency for each closed-loop optical waveguide.

19. (canceled)

20. The detector according to claim 14, wherein the processing unit is configured to determine a group refractive index of the closed-loop optical waveguide and/or an optical wavelength inside the closed-loop optical waveguide for each closed-loop optical waveguide based on the determined at least one resonance frequency for that closed-loop optical waveguide.

21. An optical sensor, comprising the optical detector according to claim 13; and
a sensor processing unit configured to output a sensor signal based on data obtained by the optical detector.

22. The optical sensor according to claim 21, wherein the sensor processing unit is configured to output a sensor signal based on a comparison between at least part of the IT data for each closed-loop optical waveguide and reference data, wherein said at least part of the IT data comprises at least one resonance frequency at which resonance occurs for each closed-loop optical waveguide based on the IT data for that closed-loop optical waveguide.

23.-26. (canceled)

27. The optical sensor according to claim 21, wherein the tunable monochromatic light source of the optical detector is configured to repeatedly vary the wavelength of the light coupled into the input end of the input optical waveguide within the same scanning range during a plurality of scans, and wherein the processing unit of the optical detector is configured to determine said at least one resonance frequency for each closed-loop optical waveguide for each scan,
wherein the sensor processing unit is configured to output a sensor signal based on a comparison of at least part of the IT data for each closed-loop optical waveguide for different scans.

28. The sensor according to claim 21, wherein each of the input optical waveguide, output optical waveguide, and closed-loop optical waveguides of the optical detector is a buried channel waveguide, a ridge channel waveguide, or a strip-loaded channel waveguide of which a waveguide core is made of Si, SiN, SiON, Al₂O₃, TiO, or AlN, and of which a waveguide cladding is made of SiO₂, PDMS, or PMMS, and/or is formed by a fluid that flows or is arranged over the cascaded optical ring resonator during use;
wherein the cladding layer of at least one closed-loop optical waveguide is connected to or at least partially formed by a sensing layer that is configured to couple to specific molecules, wherein as a result of said coupling, the refractive index of the cladding layer changes;
wherein the sensing layer comprises a gas absorbing or gas reacting layer, an antibody or an antigen.

29. A method for detecting the quantity and/or presence of a specific molecules in a fluid, comprising:
providing the optical sensor as defined in claim 28;
allowing the fluid to flow over the cladding layer that is connected to or at least partially formed by said sensing layer of at least one closed-loop optical waveguide of the optical sensor; and
detecting the quantity and/or presence of the specific molecules in dependence of the sensor signal.

30. An optical detection method, comprising:
providing a cascaded optical ring resonator comprising an input optical waveguide having an input end and an output optical waveguide having an output end, and a plurality of closed-loop optical waveguides that are each optically coupled to the input optical waveguide for allowing light to couple from the input optical waveguide into the closed-loop waveguide, and that are each optically coupled to the output optical waveguide for allowing light to couple from the closed-loop waveguide into the output optical waveguide;
coupling light into the input end of the input optical waveguide of which a frequency of the light is varied within a scanning range;
detecting light at the output end of the output optical waveguide and outputting a detector signal; and
processing the detector signal,
wherein said processing the detector signal comprises obtaining Transform, T, data by performing a first transform on the detector signal, selecting respective T data for each of the closed-loop optical waveguides among the T data, and performing a second transform being an inverse of the first transform on the selected respective T data for each of the closed-loop optical waveguides, and
wherein the first transform is configured for transforming data in the time domain to data in the frequency domain.
